(19) United States
(12) Patent Application Publication
(10) Pub. No.: US 2013/0175295 A1
(43) Pub. Date: Jul. 11, 2013

(54) SYSTEM FOR SAMPLING AND DISPLAY OF A PLURALITY OF BOUTIQUE BEERS

(71) Applicants: Edwin Wei Min Koh, Carlton (AU); Ta-Loong Lyndon Heng, Neutral Bay (AU); Shigao Wong, Collingwood (AU); Muhammad Iqbal Ameer Ali, Kuala Lumpur (MY); Wong Yuen Chow, Singapore (SG)

(72) Inventors: Edwin Wei Min Koh, Carlton (AU); Ta-Loong Lyndon Heng, Neutral Bay (AU); Shigao Wong, Collingwood (AU); Muhammad Iqbal Ameer Ali, Kuala Lumpur (MY); Wong Yuen Chow, Singapore (SG)

(73) Assignee: BIERO PTY LTD, Melbourne, Victoria (AU)

(21) Appl. No.: 13/642,506

(22) PCT Filed: Apr. 20, 2011
(86) PCT No.: PCT/AU2011/000461

§ 371 Date: Jan. 2, 2013

(30) Foreign Application Priority Data
Apr. 20, 2010 (AU) 2010901657

(51) Int. Cl. B67D 1/08

(52) U.S. Cl. CPC B67D 1/0867
USPC 222/129; 222/146.6; 222/185.1

(57) ABSTRACT

A beer sampling system for sampling one or more beverages such as beer from a range of bottled beverages, the system including at least one beer sampling assembly having: a support base frame; a canister removably mounted on the support base frame, the canister having an inner transparent member and a first and second transparent outer sleeve members, wherein the first outer sleeve member is adapted to receive a volume of bottled beer under pressure, and wherein the second outer sleeve member is adapted to receive and circulate a heat exchanging liquid to maintain the beer in the first outer sleeve at a drinking temperature; a tap mounted on the support base frame in liquid communication with the first outer sleeve of the canister for dispensing a sample of a beverage; a beverage clamp head interconnectable to both: a source of inert gas such as carbon dioxide and the first outer sleeve member of the canister; a refrigeration means for controlling the temperature of the heat exchanging liquid; a pump means for pumping the heat exchanging liquid to the second outer sleeve member, wherein the second outer sleeve member, refrigeration means and pumping means form a circuit for flow of heat exchange fluid; an actuator means for operating the system; and wherein in an operating condition a bottle of beer is placed with open end in the bottle receiving portion of the beverage clamp head, and the actuator means controls flow of inert gas such as carbon dioxide from a source of inert gas into the bottle via the siphon, and wherein beer from the bottle is transferred from the bottle to the first outer sleeve member where the beer is maintained under pressure in a sealed condition, and wherein a sample of the bottled beer can be obtained by operation of the tap.

### FIELD OF THE INVENTION

The present invention relates to a system for the efficient sampling of one or more of a plurality of beverages such as beer. More particularly the present invention relates to a system which is both effective to allow sampling of an array of beers before purchase and adds to the overall aesthetics of a public house or bistro environment.

### BACKGROUND OF THE INVENTION

A typical bar in a licensed public house or bistro (café) dispenses alcoholic beverages such as beer from one or more beer dispensing units. It is usual for a public house or bistro to offer a limited number of premium beers from the dispensing units. Such limitations arise because generally only premium beers are provided in commercial quantities for dispensing, and generally boutique beers are too expensive.

It is known to provide premium beers in the form of ‘kegs’ for dispensing of commercial quantities of beer. Kegs of beer are usually stored in a cool-room typically at 5-10 degrees C., located beneath the dispensing units, and interconnected to the each dispensing unit by beer transfer lines.

In dispensing beer from a keg, carbon dioxide is often used to (i) provide an anaerobic environment because in the presence of oxygen the quality of beer will decline, (ii) provide bubbles to promote foam (head) formation, and (iii) to urge beer from the keg along the beer transfer line to a dispensing unit above the cool-room.

While it is usual for premium beers to be available for use in kegs, or bottles or cans, a very large range of boutique beers, both nationally and internationally, is only available in bottles ranging from 330 ml to 750 ml volume. For the discerning person(s) who may want to sample a wider range of beers for edification purposes or for trial before purchase of one or more bottles of beer of choice, this is simply not available. Currently the only way that a beer can be sampled is by purchasing a whole glass via a dispensing unit in a bar or by purchasing a bottle of beer. Clearly this limits sampling in a bar to a particular brand on tap or to purchasing a whole bottle of beer.

One small-scale apparatus called a “Beer Tube” has been available as a beer dispenser that can hold 5 or 8 pints of a beverage of choice. The ‘Beer Tube’ generally uses a 100-ounce removable hollow tube which is received on a dispensing base. The ‘Beer Tube’ is marketed as a novelty item and is usually sold at a bar or sports club to patrons with a full tube of a beverage of choice. One disadvantage of the ‘beer Tube’ is that the tube component exposes beer to oxygen hence suffers loss of carbonation (flat beer) and oxidation to occur thus reducing beer quality. A further disadvantage is that while this might be convenient to take away or drink at a table or venue, this does not allow sampling, and further a multitude of ‘Beer Tubes’ detracts from the aesthetics of a venue and requires dismantling for cleaning.

Currently however there is no commercial operation which provides for sampling of one or more beers in a large range of bottled beer without first purchasing a bottle. Most boutique bottled beer is expensive and if a purchaser does not like the beer after an initial sip, the bottle cannot simply be returned.

It would be particularly advantageous to be able to meet this deficiency while maintaining a multitude of beers in a quality condition for sampling consumption.

It is therefore an object of the present invention to address one or more problems of the prior art. A further object is to provide a system which allows sampling of a wide range of boutique beers before purchase while improving overall aesthetics of a bar or bistro. A further object of the present invention is to provide the public with a useful alternative.

### SUMMARY OF THE INVENTION

In the present invention there is disclosed a beer sampling system for sampling one or more beverages such as beer from a range of bottled beverages, the system including:
at least one beer sampling assembly having:
   a support base frame;
   a canister removably mounted on the support base frame, the canister having an inner transparent member and a first and second transparent outer sleeve members, wherein the first outer sleeve member is adapted to receive a volume of bottled beer under pressure, and wherein the second outer sleeve member is adapted to receive and circulate a heat exchanging liquid to maintain the beer in the first outer sleeve at a drinking temperature;
   a tap mounted on the support base frame in liquid communication with the first outer sleeve of the canister for dispensing a sample of a beverage;
a beverage clamp head interconnectable to both a source of inert gas such as carbon dioxide and the first outer sleeve member of the canister;
a refrigeration means for controlling the temperature of the heat exchanging liquid;
a pumping means for pumping the heat exchanging liquid to the second outer sleeve member, wherein the second outer sleeve member, refrigeration means and pumping means form a circuit for flow of heat exchange fluid;
an actuator means for operating the system; and
wherein in an operating condition a bottle of beer is placed with open end in the bottle receiving portion of the beverage clamp head, and the actuator means controls flow of inert gas such as carbon dioxide from a source of inert gas into the bottle via the siphon, and wherein beer from the bottle is transferred from the bottle to the first outer sleeve member where the beer is maintained under pressure in a sealed condition, and wherein a sample of the bottled beer can be obtained by operation of the tap.

The present invention provides a novel and innovative means of allowing the public to experience the taste of one or more beers including boutique and premium beers in a bar or bistro without the need to purchase a full glass of beer to try a sample or indeed go to the expense of purchasing a whole bottle and thereafter wasting the contents, not to mention cost of purchasing the bottle, if the purchaser does not like the beer on first taste.

A further benefit of the instant invention compared to the prior art is that the canister is sealed and under pressure so that beer in the canister can be maintained for long periods of time substantially without exposure to oxidation and loss of beer quality.

The beverage bottle clamp head can include:
a beverage bottle receiving portion for receiving an open end portion of a bottle in a sealed condition;
a siphon extending from the beverage bottle receiving portion whereby in use the siphon is received within the bottle;
an inlet for ingress of carbon dioxide or other inert gas, the inlet being in fluid communication with the siphon; and
an outlet for egress of beer from a bottle received in the bottle receiving portion, the outlet being interconnected to the first outer sleeve so that liquid may be transferred from the bottle under pressure to the first outer sleeve.

In a related aspect of the present invention there is discloses a beer sampling system for sampling one or more beverages such as beer from a range of bottled beverages, the system including:
at least one beer sampling assembly having:
   a support base frame;
   a canister removably mounted on the support base frame, the canister having an inner transparent member and a first and second transparent outer sleeve members, wherein the first outer sleeve member is adapted to receive a volume of bottled beer under pressure, and wherein the second outer sleeve member is adapted to receive and circulate a heat exchanging liquid to maintain the beer in the first outer sleeve at a drinking temperature;
   a tap mounted on the support base frame in liquid communication with the first outer sleeve of the canister for dispensing a sample of a beverage;
   a beverage clamp head interconnectable to both a source of inert gas such as carbon dioxide and the first outer sleeve member of the canister;
a refrigeration means for controlling the temperature of the heat exchanging liquid;
a pumping means for pumping the heat exchanging liquid to the second outer sleeve member, wherein the second outer sleeve member, refrigeration means and pumping means form a circuit for flow of heat exchange fluid;
an actuator means for operating the system; and
wherein in an operating condition a bottle of beer is placed with open end in the bottle receiving portion of the beverage clamp head, and the actuator means controls flow of inert gas such as carbon dioxide from a source of inert gas into the bottle via the siphon, and wherein beer from the bottle is transferred from the bottle to the first outer sleeve member where the beer is maintained under pressure in a sealed condition, and wherein a sample of the bottled beer can be obtained by operation of the tap.

In a related aspect of the present invention there is disclosed a beer sampling system for sampling one or more beverages such as beer from a range of bottled beverages, the system including:
at least one beer sampling assembly having:
   a support base frame;
   a canister removably mounted on the support base frame, the canister having an inner transparent member and a first and second transparent outer sleeve members, wherein the first outer sleeve member is adapted to receive a volume of bottled beer under pressure, and wherein the second outer sleeve member is adapted to receive and circulate a heat exchanging liquid to maintain the beer in the first outer sleeve at a drinking temperature;
   a tap mounted on the support base frame in liquid communication with the first outer sleeve of the canister for dispensing a sample of a beverage;
a beverage clamp head interconnectable to both a source of inert gas such as carbon dioxide and the first outer sleeve member of the canister, the beverage clamp including:
   a beverage bottle receiving portion for receiving an open end portion of a bottle in a sealed condition;
   a siphon extending from the beverage bottle receiving portion whereby in use the siphon is received within the bottle;
   an inlet for ingress of carbon dioxide or other inert gas, the inlet being in fluid communication with the siphon;
   an outlet for egress of beer from a bottle received in the bottle receiving portion, the outlet being interconnected to the first outer sleeve so that liquid may be transferred from the bottle under pressure to the first outer sleeve;
a refrigeration means for controlling the temperature of the heat exchanging liquid;
a pumping means for pumping the heat exchanging liquid to the second outer sleeve member, wherein the second outer sleeve member, refrigeration means and pumping means form a circuit for flow of heat exchange fluid;
an actuator means for operating the system;
wherein in an operating condition a bottle of beer is placed with open end in the bottle receiving portion of the beverage clamp head, and the actuator means controls flow of inert gas such as carbon dioxide from a source of inert gas into the bottle via the siphon, and wherein beer from the bottle is transferred from the bottle to the first outer sleeve member where the beer is maintained under pressure in a sealed condition and wherein a sample of the bottled beer can be obtained by operation of the tap.

A further benefit of the instant invention compared to the prior art is that with the arrangement of transparent member and outer sleeve members, the colour of the beer in the canister is displayed, and the volume of beer in the canister appears greater than the actual volume hence adding to the overall experience and ambience of a bar or bistro.

The system of the present invention can include a plurality of beer sampling assemblies so that a range of bottled beer can be separately sampled.

The first outer sleeve member of the canister preferably has a capacity of up to about five (5) litres of beer.

The beverage clamp head can be interconnected to the canister and source of inert gas by means of a fluid transfer conduit. The beverage clamp head is preferably removably interconnected to the fluid transfer conduit(s) so that in a non-operating condition, the beverage clamp head can be removed and stored.

The system can further include a temperature and pressure controllers to help maintain beer in a state substantially free of oxidation and at an effective temperature for consumption. In this case beer can be optimally maintained in the canister so as to retain effective amounts of dissolved carbon dioxide sufficient for carbonation and foam head on a sample beer.

Preferably the heat exchanging liquid is a glycol such as polyethylene glycol which is maintained at a sufficiently low temperature by the refrigeration means and wherein the glycol is pumped by the pumping means in a circuitous pathway through the second outer sleeve member and back through the refrigeration means so that heat exchange liquid can be chilled. Beer is therefore kept substantially at a uniform drinking temperature throughout the canister.

The beer sampling assembly can further include a shroud assembly mounted on or over the support base frame. The shroud assembly can be adapted to receive a lower end portion of the canister and includes a cut-out portion to receive the dispensing tap.

The canister can further include a sub-assembly having a cradle and a top plate, wherein the cradle is mountable to the support base frame and includes a plurality of fluid transfer ports for allowing (i) passage of heat exchange liquid between the second sleeve member and a source of heat exchange liquid, (ii) transfer of beer from the beverage clamp head to the first outer sleeve member, and (iii) transfer of beer from the first outer sleeve member to the dispensing tap.

The canister can further include a structural member mounted centrally of the inner transparent member extending between the base plate and top plate. The structural member provides a strengthening element to support the canister in position relative to the support base frame.

Further exemplifications of the present invention will be described as follows with reference to the accompanying drawings. A brief description of the drawings follows:

### BRIEF DESCRIPTION OF THE DRAWINGS

FIG. 1 is a schematic representation of a system for dispensing a sample of a beverage such as beer in side elevation in accordance with the present invention;

FIG. 2 is a schematic representation of a beer sampling assembly component of the system from a front perspective in accordance with the present invention;

FIG. 3 is a cross-sectional schematic of the beer sampling assembly shown in FIG. 2;

FIG. 4 is an perspective view of a shroud assembly from front above elevation in accordance with the present invention;

FIG. 5 is an exploded view of a support base frame structure in accordance with the present invention;

FIG. 6A and 6B represent perspective view from rear above and front below respectively of an assembled support base frame in accordance with FIG. 5;

FIG. 7 is a schematic view of a system in accordance with the present invention including a plurality of beer sampling assemblies.

### DETAILED DESCRIPTION OF THE PREFERRED EMBODIMENTS WITH REFERENCE TO THE ACCOMPANYING DRAWINGS

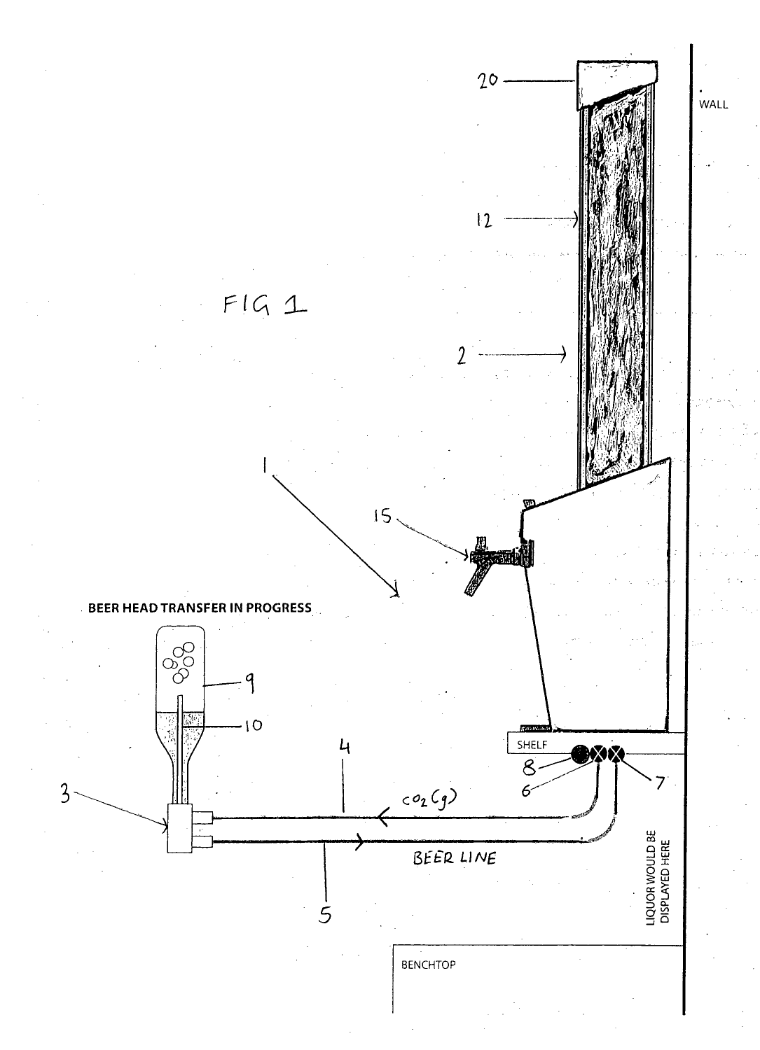

Referring to FIG. 1 there is shown a beer sampling system 1 in accordance with the present invention for sampling beer. The system includes a beer sampling assembly 2 interconnected to a beverage clamp head 3 by fluid transfer lines 4 and 5. The transfer lines 4 and 5 are connected at one end to the beer sampling assembly by means of valves 6 and 7.

The valve means 6 is operably connected to a source of compressed inert gas such as carbon dioxide or nitrogen (not shown), and the valve means are operated by an actuator switch 8.

In an operating condition as shown in FIG. 1, a portion of the clamp head receives a bottle of beer 9 in an inverted position, and valve means 6 and 7 are opened by operation of actuator switch 8 such that inert gas (CO₂) is urged under pressure through fluid transfer line 4 and into the bottle via siphon tube 10 inserted in the bottle.

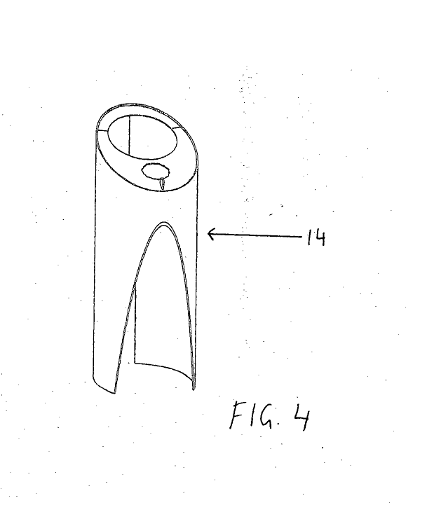

In the presence of CO₂ gas pressure, beer in the bottle 9 is urged out of the bottle into fluid transfer line 5. In the system, a fluid transfer line (not shown) extends between valve 7 and an inlet port 11 (best seen in FIG. 3) in the beer sampling assembly to allow transfer of beer under pressure to a canister 12 of the beer sampling assembly.

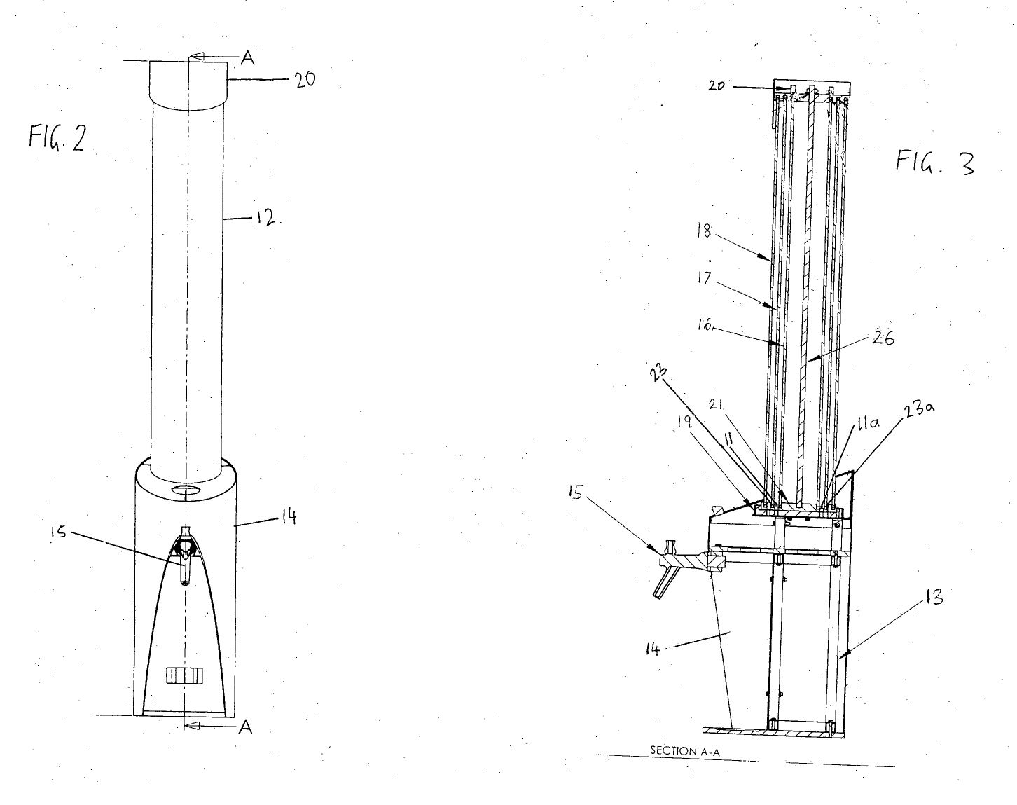

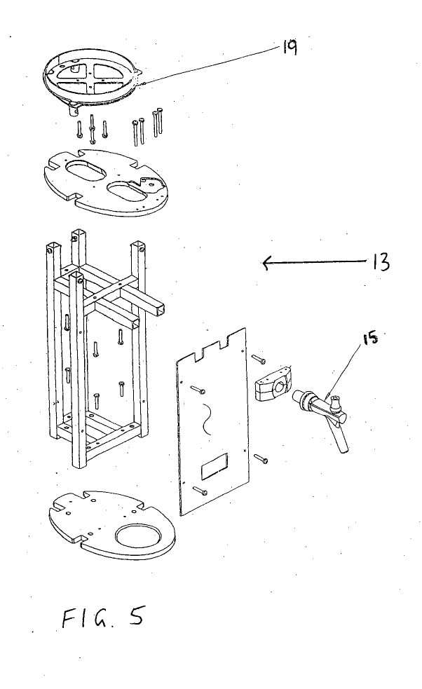

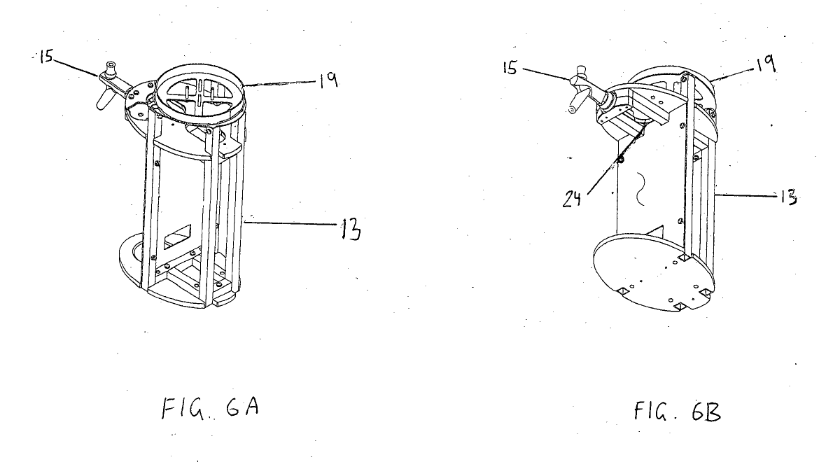

As shown in FIGS. 1, 2 and 3, the beer sampling assembly 2 includes a canister 12 mounted on a support base frame 13 (best seen in FIGS. 5 and 6). The base frame and lower end portion of the canister are hidden by a shroud 14 mounted to the base frame. The shroud (best seen in FIG. 4) is of generally elliptical configuration with a rolled inner edge, and includes a cut-out portion for receiving a tap 15 therethrough.

Referring to FIG. 3, the canister 12 is of generally cylindrical shape and includes an inner transparent cylinder 16 having a first outside diameter surrounded by a first and second transparent outer cylindrical sleeve 17 and 18 having progressively larger outside diameters respectively. The transparent cylinders can be made from plastic materials or glass.

The space exhibited between the inner cylinder 16 and first outer cylindrical sleeve 17 is adapted to receive a volume of beverage under pressure. In this embodiment the volume of beer is about five (5) litres however the respective diameter of the cylinders can be varied to accommodate a larger volume of beer. When beer is received within the first outer sleeve, the combination of first sleeve and inner cylinder gives an appearance to the canister of a larger volume of beer than five litres. A further advantage of this arrangement of cylinders is that the colour of a particular beer may be displayed giving a distinctive overall appearance. When a plurality of beer sampling assemblies is arranged in series, the range of beer colours provides a novel aesthetic experience.

The second outer cylindrical sleeve 18, which has an outside diameter greater than the both the inner cylinder and first outer sleeve, is adapted to receive and circulate a heat exchanging liquid to maintain the beer in the first outer sleeve at a suitable drinking temperature throughout the canister.

In one embodiment (not shown) a source of polyethylene glycol is first chilled to about 3 degrees in a refrigerator and pumped into and circulated through the space between the first and second outer sleeves. During circulation, heat from the beer received in the adjacent sleeve space is transferred and polyethylene glycol returned to the refrigerator for chilling and further circulation. Therefore as circulation occurs the temperature of beer is lowered to a suitable drinking temperature.

In an embodiment shown in FIG. 3, the canister further includes a sub assembly. The sub assembly comprises a beer canister cradle 19 (refer FIG. 5) mounted on the support base frame and a top plate 20. The beer canister cradle 19 includes a bottom plate 21 and two sets of fluid transfer ports 11 and 11a and 23 and 23a, which in a fitted condition extend into sleeve spaces formed between (a) the inner cylindrical sleeve 16 and first outer sleeve 17, and (b) the first outer sleeve 17 and the second outer sleeve 18.

In a first set of the fluid transfer ports 11 and 11a, port 11a is interconnected to the beer transfer conduit 5. Port 11a of the first set is connected downstream from the valve means 7. In an operating condition with valve means 7 open, beer is transferred from the beer head clamp 3 along conduit 5 and received in the canister space between the inner transparent cylinder 16 and the first outer sleeve 17. The second port 11 in the first set of fluid transfer ports is connected to the dispensing tap 15 via a transfer conduit 24 (best seen in FIG. 6B).

In the second set of fluid transfer ports 23 and 23a, a first transfer port 23 is interconnected to a source of heat exchange fluid (not shown). The second port 23a in the second set of transfer ports is in turn connected to the refrigerator (not shown) for chilling the polyethylene glycol once heat exchange has occurred.

When the heat exchange liquid is chilled to a suitable temperature the heat exchange liquid is pumped by a pumping means (not shown) into the space provided between the first and second outer sleeves. The transfer ports 23 and 23a allow continual circulation of the heat exchange liquid throughout the canister space provided between the first and second sleeves and passing through the refrigerator for circulation of chilled heat exchange fluid to assist maintain the temperature of the beer at a drinking temperature.

Referring to FIG. 3 the top plate 20 of the canister sub assembly is sealingly engaged on the top portion of the canister. In FIG. 3 there is further shown a canister centre rod 26 which extends between the top plate 20 and bottom plate 21. The centre rod 26 improves the structural integrity of the canister in a mounted condition.

The canister is substantially maintained in a sealed and pressurised condition in storage and operating conditions to substantially prevent air oxidation and maintain an effective amount of dissolved gas for carbonisation.

The system can further include a temperature and pressure controllers to help maintain beer in a state substantially free of oxidation and at an effective temperature for consumption. In this case the temperature and pressure can be programmed to optimally maintain beer in the canister with effective amounts of dissolved carbon dioxide sufficient for carbonation and foam head on a sample beer.

As shown in FIG. 1, prior to operating the system, a bottle of beer is sealingly placed with open end in the bottle receiving portion of the beverage clamp head. The actuator means when operated opens valve means 6 and 7 to initiate flow of carbon dioxide from an external source along transfer conduit 4 into the bottle 9 via the siphon tube 10. Under pressure beer is transferred between the clamp head and canister along beer transfer conduit 5.

In an operating condition, the system urges beer from the bottle from the bottle to the first outer sleeve member under pressure through inlet port 11a. Beer is maintained in the canister under pressure in a sealed condition to maintain beer in an optimal quality for sampling.

A sample of the bottled beer can be obtained by operation of the tap. If the canister requires more beer, it is a simple operation to inert a fresh bottle in the clamp head and start the operation over.

In a preferred form, the transfer conduits 4 and 5 are connected to the valve means 6 and 7 by quick release connectors so that allow bar staff to disconnect the beer clamp head for storage.

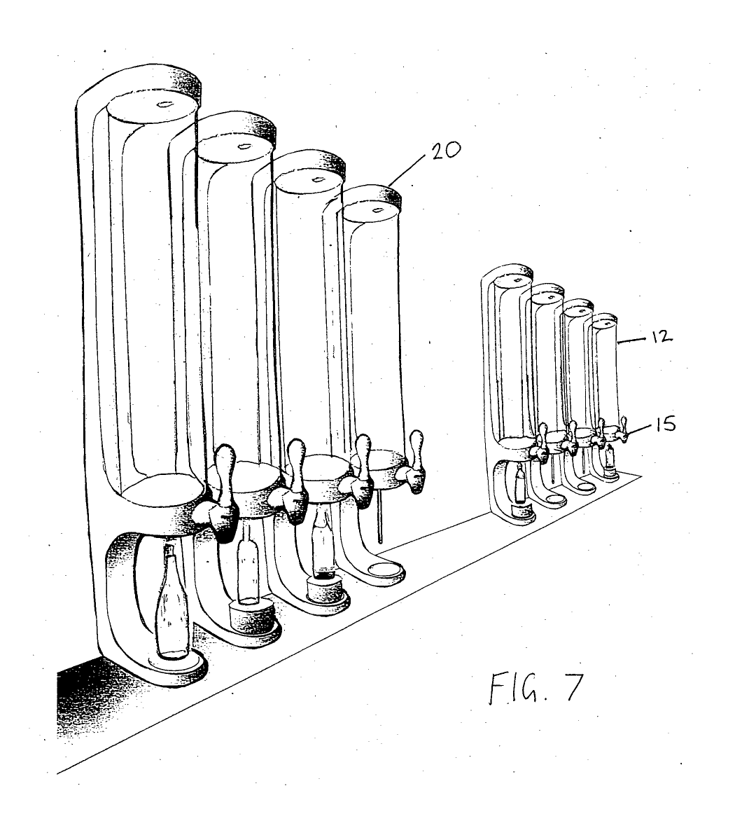

Now referring to FIG. 7, there is shown a beer sampling system including a series of beer sampling assemblies. In this embodiment, a plurality of bottled beers can be sampled whereby each assembly can receive a different beer for sampling. The series of beer sampling assemblies allows a variety of beer to be presented in the beer sampling assemblies. This provides a range of beer colours, and therefore a distinct visual appearance, which enhances the ambience and experience of sampling beer.

More importantly, the system of the present invention allows a person to sample a beer or range of beers, which are available in bottled form from both a visual and taste perspective before determining which beer is a favourite. Hence one or more beers including boutique and premium beers in a bar or bistro can be sampled without the need to purchase a full glass of beer or indeed go to the expense of purchasing a whole bottle and thereafter wasting the contents, not to mention cost of purchasing the bottle, if the purchaser does not like the beer on first taste.

1. A beer sampling system for sampling one or more beverages such as beer from a range of bottled beverages, the system including:
at least one beer sampling assembly having:
a support base frame;
a canister removably mounted on the support base frame, the canister having an inner transparent member and a first and second transparent outer sleeve members, wherein the first outer sleeve member is adapted to receive a volume of bottled beer under pressure, and wherein the second outer sleeve member is adapted to receive and circulate a heat exchanging liquid to maintain the beer in the first outer sleeve at a drinking temperature;
a tap mounted on the support base frame in liquid communication with the first outer sleeve of the canister for dispensing a sample of a beverage;
a beverage clamp head interconnectable to both a source of inert gas such as carbon dioxide and the first outer sleeve member of the canister, the beverage clamp including:
a beverage bottle receiving portion for receiving an open end portion of a bottle in a sealed condition;
a siphon extending from the beverage bottle receiving portion whereby in use the siphon is received within the bottle;
an inlet for ingress of carbon dioxide or other inert gas, the inlet being in fluid communication with the siphon;
an outlet for egress of beer from a bottle received in the bottle receiving portion, the outlet being interconnected to the first outer sleeve so that liquid may be transferred from the bottle under pressure to the first outer sleeve;
a refrigeration means for controlling the temperature of the heat exchanging liquid;
a pumping means for pumping the heat exchanging liquid to the second outer sleeve member, wherein the second outer sleeve member, refrigeration means and pumping means form a circuit for flow of heat exchange fluid;
an actuator means for operating the system;
wherein in an operating condition a bottle of beer is placed with open end in the bottle receiving portion of the beverage clamp head, and the actuator means controls flow of inert gas such as carbon dioxide from a source of inert gas into the bottle via the siphon, and wherein beer from the bottle is transferred from the bottle to the first outer sleeve member where the beer is maintained under pressure in a sealed condition and wherein a sample of the bottled beer can be obtained by operation of the tap.
include a plurality of beer sampling assemblies so that a range of bottled beer can be separately sampled.

2. A beer sampling system according to claim 1 wherein the first outer sleeve member of the canister preferably has a capacity of up to about five litres of beer.

3. A beer sampling system according to claim 1 wherein the beverage clamp head can be interconnected to the canister and source of inert gas by means of a fluid transfer conduit. The beverage clamp head is preferably removably interconnected to the fluid transfer conduit(s) so that in a non-operating condition, the beverage clamp head can be removed and stored.

4. A beer sampling system according to claim 1 further including a temperature and pressure controllers to help maintain beer in a state substantially free of oxidation and at an effective temperature for consumption so that beer can be optimally maintained in the canister to retain effective amounts of dissolved carbon dioxide sufficient for carbonation and foam head on a sample beer.

5. A beer sampling system according to claim 1 wherein the heat exchanging liquid is a glycol such as polyethylene glycol which is maintained at a sufficiently low temperature by the refrigeration means and wherein the glycol is pumped by the pumping means in a circuitous pathway through the second outer sleeve member and back through the refrigeration means so that heat exchange liquid can be chilled to maintain beer substantially at a uniform drinking temperature throughout the canister.

6. A beer sampling system according to claim 1 further including a shroud assembly mounted on or over the support base frame for receiving a lower end portion of the canister and includes a cut-out portion to receive the dispensing tap.

7. A beer sampling system according to claim 1 wherein the canister further includes a sub-assembly having a cradle and a top plate, wherein the cradle is mountable to the support base frame and includes a plurality of fluid transfer ports for allowing (i) passage of heat exchange liquid between the second sleeve member and a source of heat exchange liquid, (ii) transfer of beer from the beverage clamp head to the first outer sleeve member, and (iii) transfer of beer from the first outer sleeve member to the dispensing tap.

8. A beer sampling system according to claim 7 wherein the canister further includes a structural member mounted centrally of the inner transparent member extending between the base plate and top plate for providing a strengthening element to support the canister in position relative to the support base frame.

9. A beer sampling system for sampling one or more beverages such as beer from a range of bottled beverages, the system including:
at least one beer sampling assembly having:
a support base frame;
a canister removably mounted on the support base frame, the canister having an inner transparent member and a first and second transparent outer sleeve members, wherein the first outer sleeve member is adapted to receive a volume of bottled beer under pressure, and wherein the second outer sleeve member is adapted to receive and circulate a heat exchanging liquid to maintain the beer in the first outer sleeve at a drinking temperature;
a tap mounted on the support base frame in liquid communication with the first outer sleeve of the canister for dispensing a sample of a beverage;
a beverage clamp head interconnectable to both a source of inert gas such as carbon dioxide and the first outer sleeve member of the canister;
a refrigeration means for controlling the temperature of the heat exchanging liquid;
a pumping means for pumping the heat exchanging liquid to the second outer sleeve member, wherein the second outer sleeve member, refrigeration means and pumping means form a circuit for flow of heat exchange fluid;
an actuator means for operating the system; and
wherein in an operating condition a bottle of beer is placed with open end in the bottle receiving portion of the beverage clamp head, and the actuator means controls flow of inert gas such as carbon dioxide from a source of inert gas into the bottle via the siphon, and wherein beer from the bottle is transferred from the bottle to the first outer sleeve member where the beer is maintained under pressure in a sealed condition, and wherein a sample of the bottled beer can be obtained by operation of the tap.

10. A beer sampling system according to claim 9 wherein the beverage bottle clamp head includes:
a beverage bottle receiving portion—for receiving an open end portion of a bottle in a sealed condition;
a siphon extending from the beverage bottle receiving portion whereby in use the siphon is received within the bottle;
an inlet for ingress of carbon dioxide or other inert gas, the inlet being in fluid communication with the siphon; and
an outlet for egress of beer from a bottle received in the bottle receiving portion, the outlet being interconnected to the first outer sleeve so that liquid may be transferred from the bottle under pressure to the first outer sleeve.

11. A beer sampling system as substantially hereinbefore described with to the accompanying drawings.
